(19) United States
(12) Patent Application Publication
(10) Pub. No.: US 2015/0014012 A1
(43) Pub. Date: Jan. 15, 2015

(54) OSCILLATION REDUCING SUSPENSION DEVICE FOR A FAN MOTOR OF A COMBUSTION-POWERED TOOL

(71) Applicant: Basso Industry Corp., Taichung (TW)

(72) Inventors: An-Gi Liu, Taichung (TW); Fu-Ying Huang, Taichung (TW)

(21) Appl. No.: 14/329,094

(22) Filed: Jul. 11, 2014

(30) Foreign Application Priority Data
Jul. 15, 2013 (TW) 102213334

(51) Int. Cl. B25F 5/00; B25C 1/08

(52) U.S. Cl. CPC B25F 5/006; B25C 1/08
USPC 173/162.1

(57) ABSTRACT

An oscillation reducing suspension device for a fan motor of a combustion-powered tool includes a holding web member sleeved on the fan motor, upper and lower retaining members disposed to secure the holding web member on the fan motor, upper and lower damping units which are respectively brought into abutting engagement with upper and lower surfaces of the holding web member, and an upward-movement restricting member securely mounted on an upper major surface of a cylinder head.

Due to engagement between the restricting member and the upper damping unit, the upper and lower damping units can absorb impact resulting from oscillating movement of the fan motor.

### CROSS-REFERENCE TO RELATED APPLICATION

This application claims priority from Taiwanese application no. 102213334, filed on Jul. 15, 2013, the disclosure of which is incorporated in its entirety herein by reference.

### BACKGROUND OF THE INVENTION

1. Field of the Invention

This invention relates to an oscillation reducing suspension device for a fan motor of a combustion-powered tool. 2. Description of the Related Art

FIGS. 1 and 2 show a mounting system 1 for mounting a motor 12 of a gas gun disclosed in US patent application publication no. 2012/0119058. The mounting system is an oscillation reducing suspension device and includes a cylinder head 11, a rigid carrier 13 for carrying the motor 12 such that the motor 12 is disposed through the cylinder head 11 and is floatingly movable along an axis (X) , a fixing member 14 fixedly arranged at an end plane of the cylinder head 11, and a plurality of elastic elements 15 each of which is embedded into a respective embedding hole 131 of the rigid carrier 13. Each of the elastic elements 15 has a first buffering body 151 extending between one side of the rigid carrier 13 and the fixing member 14 for absorbing a positive vibrating energy of the motor 12, and a second buffering body 152 extending between the other side of the rigid carrier 13 and the cylinder head 11 for absorbing a negative vibrating energy of the motor 12. During assembly, each of the elastic elements 15 has to be squeezed into the respective embedding hole 131, which is troublesome and unfavorable for rapid production of the gas gun.

U.S. Pat. Nos. 8,511,529 and 8,695,862 also disclose an oscillation reducing suspension device for a fan motor of a combustion-powered tool.

### SUMMARY OF THE INVENTION

An object of the present invention is to provide a novel oscillation reducing suspension device for a fan motor of a combustion-powered tool. The oscillation reducing suspension device provides an advantage in the assembling of parts of the oscillation reducing suspension device.

Accordingly, an oscillation reducing suspension device for a fan motor of a combustion-powered tool of the present invention is provided. The combustion-powered tool includes a cylinder head disposed to cover a combustion chamber and has an upper major surface which defines a cavity for accommodating the fan motor. The cavity extends along a rotary axis and includes a larger-dimension upper subcavity, a smaller-dimension lower subcavity, and a shoulder surface therebetween. The smaller-dimension lower subcavity extends from the shoulder surface to terminate at a floor surface that has a passage defined therein to communicate the cavity with the combustion chamber so as to permit an armature shaft of the fan motor to extend into the combustion chamber. The oscillation reducing suspension device includes a holding member, an upward-movement restricting member, an upper damping unit, and a lower damping unit. The holding member is adapted to be secured to a barrel wall of the fan motor, and has a central region which defines a central opening for extension of the fan motor therethrough. The upward-movement restricting member has a major wall adapted to be securely mounted on the upper major surface of the cylinder head. The upper damping unit is made from an elastomeric material, and is disposed in the larger-dimension upper subcavity to surround the barrel wall of the fan motor and between the holding member and the upward-movement restricting member. The lower damping unit is made from an elastomeric material, and is disposed in the larger-dimension upper subcavity to surround the barrel wall of the fan motor and between the holding member and the shoulder surface.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded elevation view of a conventional oscillation reducing suspension device;

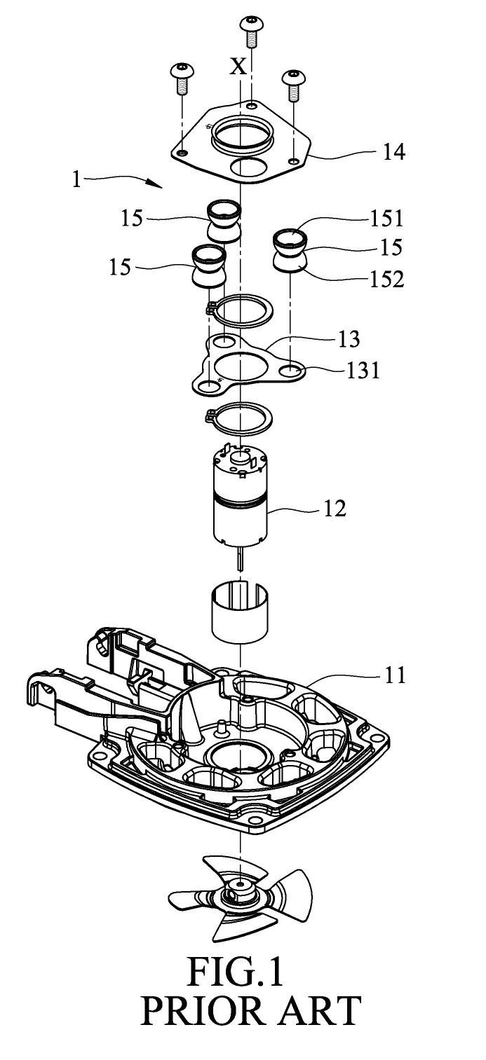

FIG. 2 is a cross-sectional view of the conventional oscillation reducing suspension device;

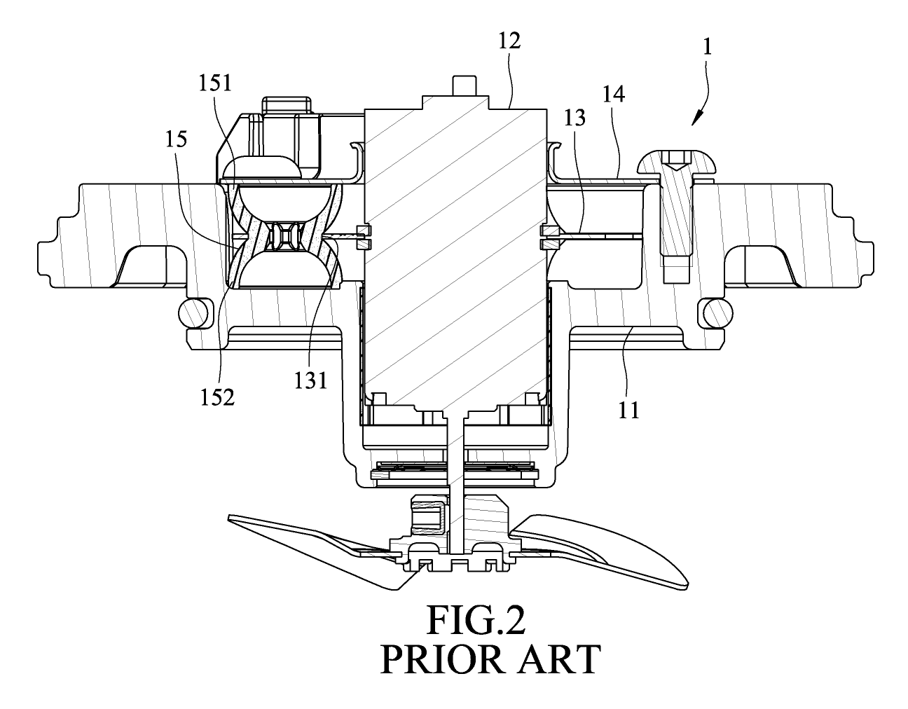

FIG. 3 is an exploded elevation view of a preferred embodiment of an oscillation reducing suspension device for a fan motor of a combustion-powered tool according to this invention;

FIG. 4 is a perspective view of the preferred embodiment in an assembled state;

FIG. 5 is a cross-sectional view of the preferred embodiment shown in FIG. 4; and

FIG. 6 is another cross-sectional view of the preferred embodiment shown in FIG. 4.

### DETAILED DESCRIPTION OF THE PREFERRED EMBODIMENT

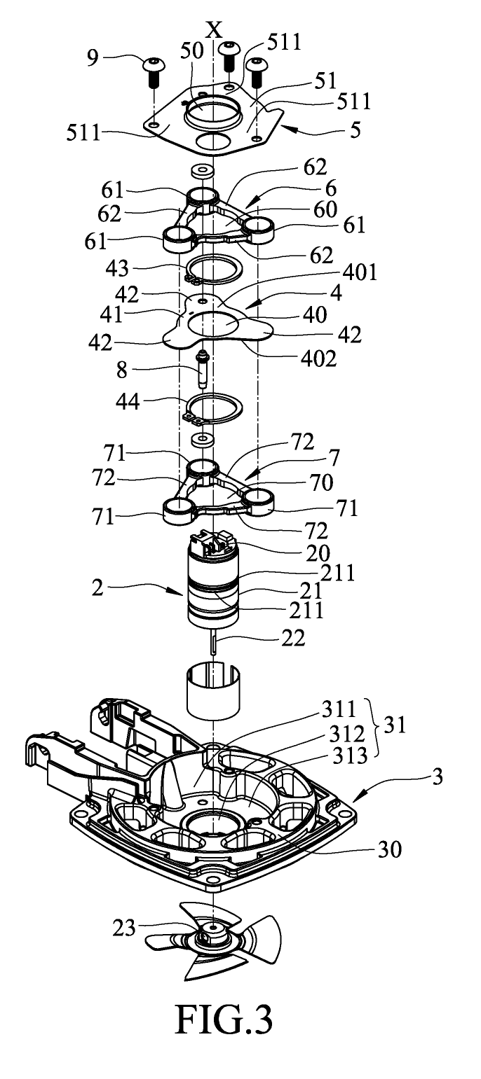

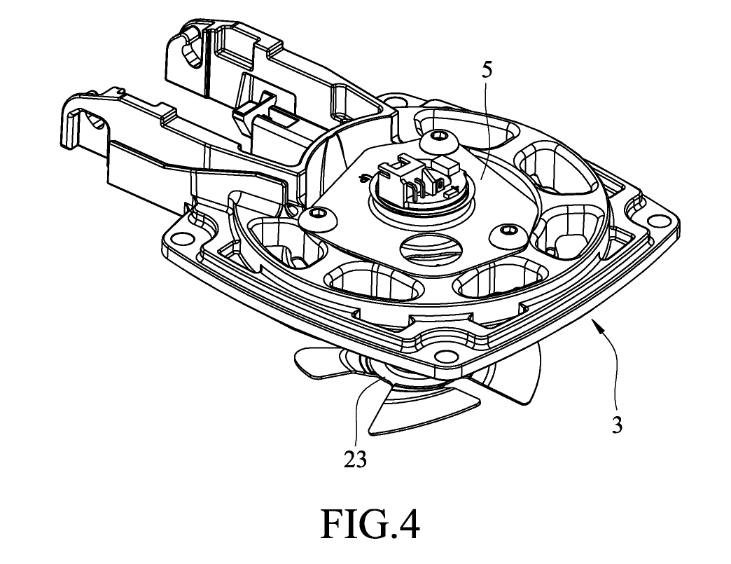

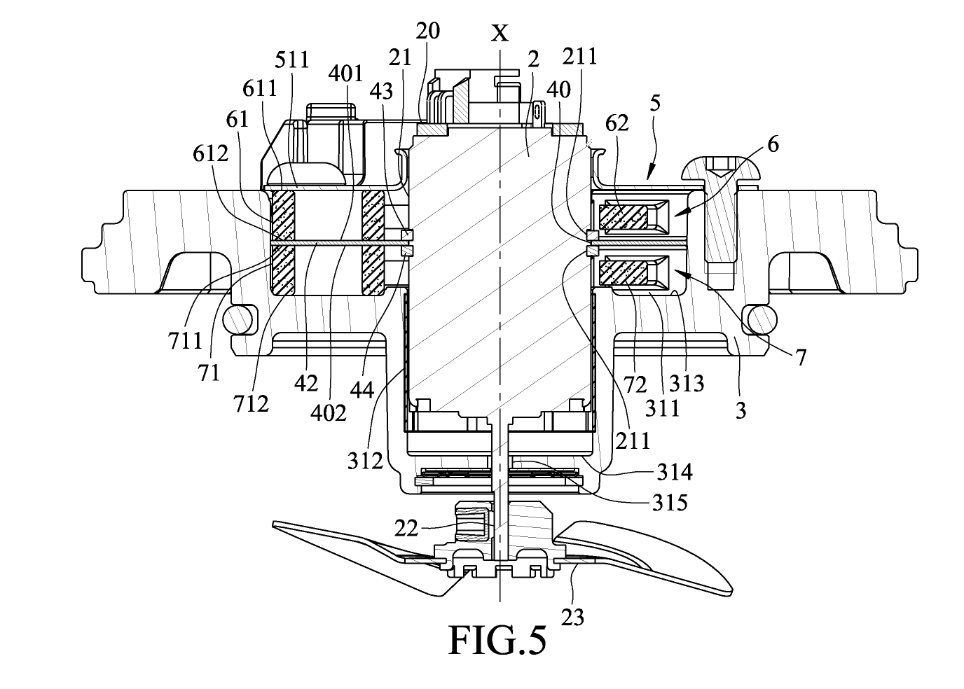

FIGS. 3 to 6 show a preferred embodiment of an oscillation reducing suspension device for a fan motor 2 of a combustion-powered tool (not shown) according to this invention. The combustion-powered tool includes a cylinder head 3 and a fan 23. The cylinder head 3 is disposed to cover a combustion chamber (not shown) and has an upper major surface 30 which defines a cavity 31 for accommodating the fan motor 2. The cavity 31 extends along a rotary axis (X) and includes a larger-dimension upper subcavity 311, a smaller-dimension lower subcavity 312, and a shoulder surface 313 therebetween. The smaller-dimension lower subcavity 312 extends from the shoulder surface 313 to terminate at a floor surface 314 (see FIG. 5) that has a passage 315 defined therein to communicate the cavity 31 with the combustion chamber so as to permit an armature shaft 22 of the fan motor 2 to extend into the combustion chamber. The fan 23 is rotated with the armature shaft 22, and is received in the combustion chamber for both circulation and exhaust purposes.

The oscillation reducing suspension device includes a holding web member 4, upper and lower retaining members 43, 44, upper and lower damping units 6, 7, and an upward-movement restricting member 5.

The holding web member 4 has a central region 41 and a plurality of abutment regions 42. The central region 41 defines a central opening 40 for extension of the fan motor 2 therethrough. The abutment regions 42 extend radially from the central region 41 and are angularly displaced from each other about the rotary axis (X).

The upper and lower retaining members 43, 44 are adapted to be mounted on a barrel wall 21 of the fan motor 2 and are respectively disposed at upper and lower sides of the central region 41 in a direction of the rotary axis (X) so as to secure the holding web member 4 to the barrel wall 21. Thus, the holding web member 4 is moved with oscillating movement of the fan motor 2.

In this preferred embodiment, the barrel wall 21 has two annular grooves 211, and each of the upper and lower retaining members 43, 44 is in form of a C-shaped hoop which is adapted to hoop around the barrel wall 21 of the fan motor 2 to be retainingly engaged with a corresponding one of the annular grooves 211.

The upper damping unit 6 is made from an elastomeric material, and is disposed in the larger-dimension upper subcavity 311 to surround the barrel wall 21 of the fan motor 2 and between the holding web member 4 and the upward-movement restricting member 5. The upper damping unit 6 includes a plurality of upper tubular members 61 which are angularly displaced from each other about the rotary axis (X). Each of the upper tubular members 61 extends along the direction of the rotary axis (X) to terminate at a first bearing end edge 611 and a first resting end edge 612 (see FIG. 5).

The lower damping unit 7 is made from an elastomeric material, and is disposed in the larger-dimension upper subcavity 311 to surround the barrel wall 21 of the fan motor 2 and between the holding web member 4 and the shoulder surface 313. The lower damping unit 7 includes a plurality of lower tubular members 71 which are angularly displaced from each other about the rotary axis (X). Each of the lower tubular members 71 extends along the direction of the rotary axis (X) to terminate at a second bearing end edge 711 and a second resting end edge 712 (see FIG. 5) that is adapted to be disposed on the shoulder surface 313. The upper and lower damping units 6, 7 are brought into abutting engagement with upper and lower surfaces 401, 402 of the holding web member 4, respectively, to permit each of the abutment regions 42 to be sandwiched between the first resting end edge 612 of a corresponding one of the upper tubular members 61 and the second bearing end edge 711 of a corresponding one of the lower tubular members 71.

The upward-movement restricting member 5 has a major wall 51 which defines a wall opening 50 for extension of an upper end 20 of the fan motor 2 therethrough, and which has a plurality of abutting regions 511 that are displaced from each other about the rotary axis (X). The major wall 51 is adapted to be securely mounted on the upper major surface 30 of the cylinder head 3 such that each of the abutting regions 511 is brought into abutting engagement with the respective first bearing end edge 611 to permit the upper and lower damping units 6, 7 to absorb impact resulting from oscillating movement of the fan motor 2.

Preferably, the upper damping unit 6 further includes a plurality of upper bridging members 62 each of which is configured to interconnect two adjacent ones of the upper tubular members 61. The upper tubular members 61 and the upper bridging members 62 cooperatively define an upper opening 60. The lower damping unit 7 further includes a plurality of lower bridging members 72 each of which interconnects two adjacent ones of the lower tubular members 71 and each of which is configured such that the upper tubular members 61 of the upper damping unit 6 are in alignment with the lower tubular members 71 of the lower damping unit 7. The lower tubular members 71 and the lower bridging members 72 cooperatively define a lower opening 70. In this embodiment, the upper and lower damping units 6, 7 are substantially the same in shape.

It should be noted that because the upper and lower tubular members 61, 71 are tubular, they can provide a relatively high degree of deformation.

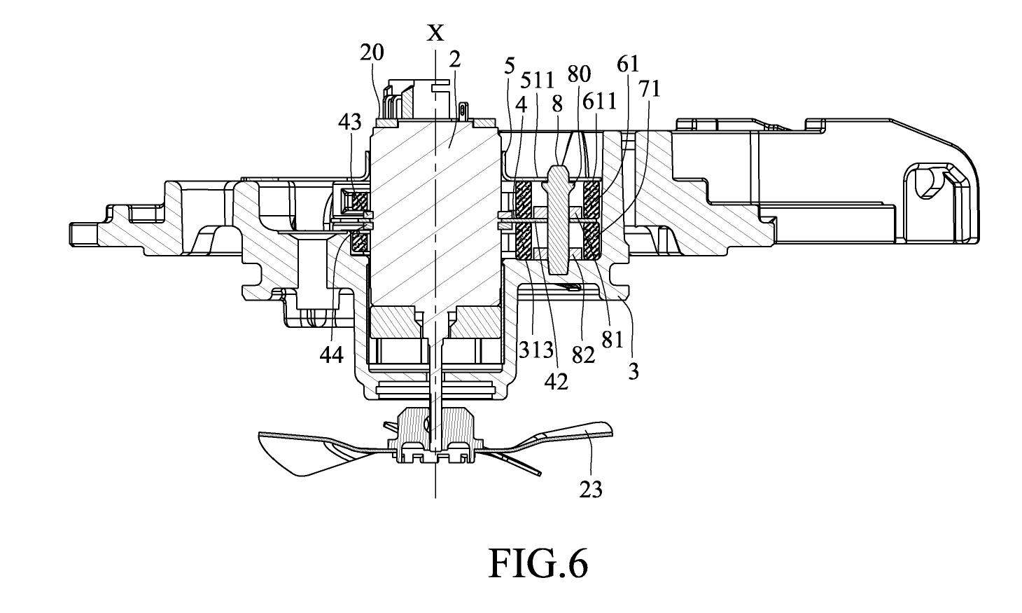

In this preferred embodiment, as best shown in FIG. 6, the oscillation reducing suspension device further includes a guiding post 8 and upper and lower washers 81, 82.

The guiding post 8 extends from the shoulder surface 313 and through one of the abutment regions 42 of the holding web member 4 and a corresponding one of the abutting regions 511 of the upward-movement restricting member 5 such that axial movement of the holding web member 4 is guided by the guiding post 8. Preferably, the guiding post 8 has a flange 80 configured such that when each of the abutting regions 511 is brought into abutting engagement with the respective first bearing end edge 611, the corresponding one of the abutting regions 511 of the upward-movement restricting member 5 rests on the flange 80. In this embodiment, the guiding post 8 is secured to the shoulder surface 313.

The upper and lower washers 81, 82 are made from a deformable material and are sleeved on the guiding post 8. The upper washer 81 is disposed in the corresponding one of the upper tubular members 61 and is in friction engagement with the guiding post 8 and said one of the abutment regions 42 through which the guiding post 8 extends. The lower washer 82 is disposed in the corresponding one of the lower tubular members 71 and is in friction engagement with the guiding post 8 and the shoulder surface 313.

In assembly, the upper and lower damping units 6, 7 can be easily sleeved on the fan motor 2. Thus, the oscillation reducing suspension device of the present invention provides an advantage of fast assembly over the prior art discussed in the background section.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. An oscillation reducing suspension device for a fan motor of a combustion-powered tool, the combustion-powered tool including a cylinder head disposed to cover a combustion chamber and having an upper major surface which defines a cavity for accommodating the fan motor, the cavity extending along a rotary axis and including a larger-dimension upper subcavity, a smaller-dimension lower subcavity, and a shoulder surface therebetween, the smaller-dimension lower subcavity extending from the shoulder surface to terminate at a floor surface that has a passage defined therein to communicate the cavity with the combustion chamber so as to permit an armature shaft of the fan motor to extend into the combustion chamber, said oscillation reducing suspension device comprising:
a holding member adapted to be secured to a barrel wall of the fan motor, and having a central region which defines a central opening for extension of the fan motor therethrough;
an upward-movement restricting member having a major wall adapted to be securely mounted on the upper major surface of the cylinder head;
an upper damping unit made from an elastomeric material, and disposed in the larger-dimension upper subcavity to surround the barrel wall of the fan motor and between said holding member and said upward-movement restricting member; and
a lower damping unit made from an elastomeric material, and disposed in the larger-dimension upper subcavity to surround the barrel wall of the fan motor and between said holding member and the shoulder surface.

2. The oscillation reducing suspension device of claim 1, wherein said holding member further has a plurality of abutment regions which extend radially from said central region and which are angularly displaced from each other about the rotary axis, said upper damping unit including a plurality of upper tubular members angularly displaced from each other about the rotary axis, each of said upper tubular members extending along the direction of the rotary axis to terminate at a first bearing end edge and a first resting end edge,
said lower damping unit including a plurality of lower tubular members angularly displaced from each other about the rotary axis, each of said lower tubular members extending along the direction of the rotary axis to terminate at a second bearing end edge and a second resting end edge that is adapted to be disposed on the shoulder surface, said upper and lower damping units being brought into abutting engagement with upper and lower surfaces of said holding member, respectively, to permit each of said abutment regions to be sandwiched between said first resting end edge of a corresponding one of said upper tubular members and said second bearing end edge of a corresponding one of said lower tubular members, said major wall defining a wall opening for extension of an upper end of the fan motor therethrough, and having a plurality of abutting regions that are displaced from each other about the rotary axis, said major wall being adapted to be securely mounted on the upper major surface of the cylinder head such that said abutting regions are brought into abutting engagement with said first bearing end edges of said upper tubular members to permit said upper and lower damping units to absorb impact resulting from oscillating movement of the fan motor.

3. The oscillation reducing suspension device of claim 2, further comprising upper and lower retaining members which are adapted to be mounted on the barrel wall of the fan motor and which are respectively disposed at upper and lower sides of said central region in a direction of the rotary axis so as to secure said holding member to the barrel wall.

4. The oscillation reducing suspension device of claim 2, wherein said holding member is web-shaped.

5. The oscillation reducing suspension device of claim 2, wherein,
said upper damping unit further includes a plurality of upper bridging members each configured to interconnect two adjacent ones of said upper tubular members,
said lower damping unit further including a plurality of lower bridging members each interconnecting two adjacent ones of said lower tubular members and each configured such that said upper tubular members of said upper damping unit are in alignment with said lower tubular members of said lower damping unit.

6. The oscillation reducing suspension device of claim 3, wherein each of said upper and lower retaining members is in form of a hoop adapted to hoop around the barrel wall of the fan motor.

7. The oscillation reducing suspension device of claim 2, further comprising a guiding post which extends from the shoulder surface and through one of said abutment regions of said holding member and a corresponding one of said abutting regions of said upward-movement restricting member such that axial movement of said holding member is guided by said guiding post.

8. The oscillation reducing suspension device of claim 7, further comprising upper and lower washers which are made from a deformable material and which are sleeved on said guiding post, said upper washer being disposed in the corresponding one of said upper tubular members and being in friction engagement with said guiding post and said one of said abutment regions, said lower washer being disposed in the corresponding one of said lower tubular members and being in friction engagement with said guiding post and said shoulder surface.

9. The oscillation reducing suspension device of claim 7, wherein said guiding post has a flange configured such that when said abutting regions are brought into abutting engagement with said first bearing end edges of said upper tubular members, the corresponding one of said abutting regions of said upward-movement restricting member rests on said flange.
